(19) United States
(12) Patent Application Publication
(10) Pub. No.: US 2026/0181310 A1
(43) Pub. Date: Jun. 25, 2026

(54) Speaker Structure

(71) Applicant: AAC Kaitai Technologies (Wuhan) CO., LTD., Wuhan, Hubei (CN)

(72) Inventors: Yu Shen, Wuhan (CN); Qiang Dan, Wuhan (CN); Yiwei Zhou, Wuhan (CN); Yang Li, Wuhan (CN)

(21) Appl. No.: 19/363,612

(22) Filed: Oct. 20, 2025

Related U.S. Application Data
(63) Continuation of application No. PCT/CN2024/140591, filed on Dec. 19, 2024.

(51) Int. Cl. H04R 1/28; H04R 7/12; H04R 17/00

(52) U.S. Cl. CPC H04R 1/2811; H04R 7/125; H04R 7/127; H04R 17/00; H04R 2307/025

(57) ABSTRACT

A speaker structure includes a base, a diaphragm, a drive part, a first transmission part, and a second transmission part; the drive part including a first drive portion and a second drive portion, the first drive portion extending from the first end towards the second end, at least a segment of the first drive portion being disposed above the cavity, the second drive portion extending from the second end towards the first end, at least a segment of the second drive portion being disposed above the cavity, the segments of the first drive portion and the second drive portion disposed above the cavity being set in a crosswise configuration, the first transmission part being in direct contact with the first drive portion and the diaphragm, respectively, the second transmission part being in direct contact with the second drive portion and the diaphragm, respectively.

### FIELD

The present disclosure relates to electroacoustic technologies, and more particularly relates to a speaker structure.

### BACKGROUND

A speaker is a transducing device converting an electrical signal to an acoustic signal or vice versa. The speaker operates on a principle that due to electromagnetic, piezoelectric, or electrostatic effect, electrical energy of an audio drives its diaphragm or cone to vibrate and resonate with the ambient atmosphere to produce sound.

Sound is produced by fluctuations of pressure in the air. A speaker disturbs a certain amount of air to cause fluctuations of pressure with a certain amount of sound produced (sound pressure). Currently, due to a miniaturized structural design, the vibration amplitude of the diaphragm in the speaker is limited, which further limits the sound pressure level of the speaker.

### SUMMARY

To address the technical problems noted supra, the present disclosure mainly provides a speaker structure, which offers a longer length for a drive part in the speaker structure without changing the existing miniaturized design, leading to a greater vibration amplitude, so that the diaphragm is also driven to vibrate with a greater amplitude, whereby a sound pressure level is raised.

A technical solution of the present disclosure provides a speaker structure. The speaker structure includes: a base having a first surface and a second surface which are oppositely set, the base having a first end and a second end which are oppositely set along a first direction; a diaphragm secured to the first surface of the base, the diaphragm and the base enclosing a cavity; a drive part disposed on the second surface, the drive part driving the diaphragm to vibrate, the drive part including a first drive portion and a second drive portion, the first drive portion extending from the first end towards the second end, at least a segment of the first drive portion being disposed above the cavity, the second drive portion extending from the second end towards the first end, at least a segment of the second drive portion being disposed above the cavity, wherein the segments of the first drive portion and the second drive portion disposed above the cavity are set in a crosswise configuration; a first transmission part disposed in the cavity, the first transmission part corresponding to the first drive portion, one end of the first transmission part being in contact with the first drive portion, another end thereof being in contact with the diaphragm; and a second transmission part disposed in the cavity, the second transmission part corresponding to the second drive portion, one end of the second transmission part being in contact with the second drive portion, another end thereof being in contact with the diaphragm.

Optionally, the first drive portion includes: a first fixed section in contact with the first end; and a plurality of a first overhang sections spaced apart from one another, one end of each of the first overhang sections being connected to the first fixed section, another end of the each of the first overhang sections being in contact with the first transmission part; and the second drive portion includes a second fixed section in contact with the second end; and a plurality of second overhang sections spaced from one another, one end of each of the second overhang sections being connected to the fixed section, another end of the each of the second overhang sections being in contact with the second transmission part, the plurality of first overhang sections and the plurality of second overhang sections being set in a crosswise configuration.

Optionally, the first transmission part is in contact with respective end portions of the first overhang sections distal from the first end; and the second transmission part is in contact with respective end portions of the second overhang sections distal from the second end.

Optionally, an interval within a first preset range is existent between orthogonal projection of each of the first overhang sections on the diaphragm and the second end; and an interval within a second preset range is existent between orthogonal projection of each of the second overhang sections on the diaphragm and the first end.

Optionally, the first preset range is from 10 μm to 2000 μm; and the second preset range is from 10 μm to 2000 μm.

Optionally, the diaphragm includes a first portion, a second portion, and a third portion which are connected sequentially, the first portion being disposed on the first surface, the third portion being in contact with the first transmission part and the second transmission part, the second portion being disposed between the first portion and the third portion; and the second portion protrudes from the first portion in a direction towards the first drive portion or protrudes from the first portion in a direction away from the first drive portion.

Optionally, the first portion, the second portion, and the third portion are organic membranes integrated into one piece.

Optionally, at least one of the first portion and the second portion is made of organic membrane, and the third portion is made of rigid membrane.

Optionally, further including: a reinforced diaphragm disposed at a side of the third portion distant from the cavity.

Optionally, the first drive portion includes a support layer, a bottom electrode layer, a piezoelectric layer, a top electrode layer, and a protective layer stacked together.

The present disclosure offers the following benefits: in the speaker structure provided according to the present disclosure, a drive part being in indirect contact with the diaphragm is set, the drive part including a first drive portion and a second drive portion, segments of the first drive portion and the second drive portion above the cavity being in a crosswise configuration so that within a limited area, the first drive portion and the second drive portion have a relatively long active length, i.e., by extending the beam length of the cantilever portion to the utmost extent, the terminal end of the cantilever of the first drive portion and the terminal end of the cantilever of the second drive portion may obtain a higher up-down movement amplitude; therefore, with a chip of a same size, a larger volume of air may be disturbed to produce a higher sound pressure level.

### BRIEF DESCRIPTION OF THE DRAWINGS

To illustrate the technical solutions in the embodiments of the disclosure more clearly, the drawings referred to in describing the embodiments will be introduced briefly. It is apparent that the drawings provided below are only some embodiments of the disclosure, and to those skilled in the art, other drawings may also be derived based on these drawings without exercise of inventive work, in which:

FIG. 1 is a structural schematic diagram of a speaker structure according to a first implementation of the present disclosure;

FIG. 2 is a top view of the speaker shown in FIG. 1;

FIG. 3 is a bottom view of the speaker shown in FIG. 1;

FIG. 4 is a local sectional view of a first drive part in the speaker structure shown in FIG. 1;

FIG. 5 is a sectional view of a vibrating state in the speaker structure shown in FIG. 1;

FIG. 6 is a bottom view of a speaker structure according to a second implementation of the present disclosure;

FIG. 7 is a sectional stereoscopic view of the speaker structure shown in FIG. 6.

### DETAILED DESCRIPTION OF EMBODIMENTS

To make the objectives, features, and advantages of the embodiments of the present disclosure more elucidated, various implementations of the disclosure will be described in detail with reference to the accompanying drawings. A person of normal skill in the art may understand, many technical details are provided herein to help readers better understand the present disclosure; however, various alterations and modifications based on the implementations described hereinafter even without these technical details can also implement the technical solutions sought for protection in the present disclosure.

In the implementations of the disclosure, the orientational or positional relationships indicated by the terms “upper”, “lower”, “left”, “right”, “front”, “rear”, “top”, “bottom”, “inner”, “outer”, “central”, “vertical”, “horizontal”, “transverse”, “longitudinal”, and etc. are orientational and positional relationships based on the drawings, which are intended only for facilitating description of the disclosure and its implementations, not for indicating or implying that the devices or elements compulsorily possess those specific orientations and are compulsorily configured and operated with those specific orientations; therefore, such terms should not be construed as limitations to the disclosure.

Moreover, in addition to indicating the orientational or positional relationships, some of the above terms may also have other meanings. For example, the term “upper” may also indicate some attachment relationship or connection relationship in some cases. For a person of normal skill in the art, specific meanings of these terms referred to therein may be understood dependent on specific situations.

In addition, the terms “mount”, “disposed”, “provided with”, “set”, “connect”, and “attach” should be understood broadly, which, for example, may refer to a fixed connection, a detachable connection, or an integral connection; which may be a mechanical connection or an electrical connection; which may be a direct connection or an indirect connection via an intermediate medium; which may also be a communication between the insides of two elements or an interaction between two elements. To a person of normal skill in the art, specific meanings of the above terms in the disclosure may be construed dependent on specific situations.

Besides, the terms such as “first” and “second” are only used for distinguishing different devices, elements or components (specific types and structures may be identical or different), which shall not be construed as indicating or implying relative importance or quantity of a referred to device, element or component. Unless otherwise indicated, “plurality” indicates two or above.

Hereinafter, various implementations of the present disclosure will be described in detail with reference to the accompanying drawings. A person of normal skill in the art may understand, in various implementations of the present disclosure, many technical details are provided herein to help readers better understand the present disclosure; however, various alterations and modifications based on the implementations described hereinafter even without these technical details can also implement the technical solutions sought for protection in the present disclosure.

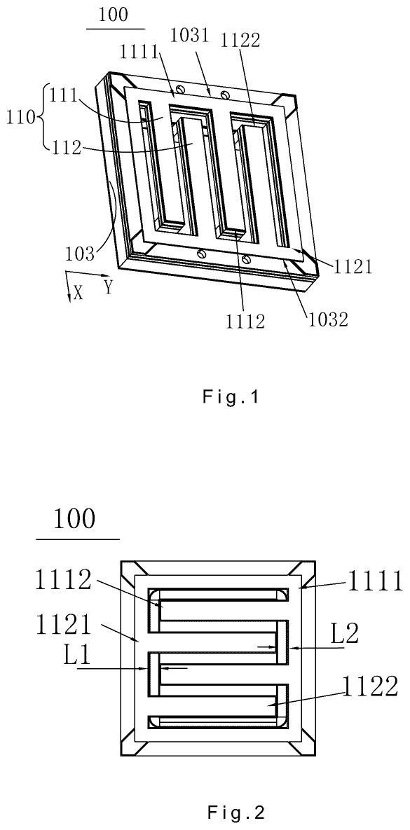

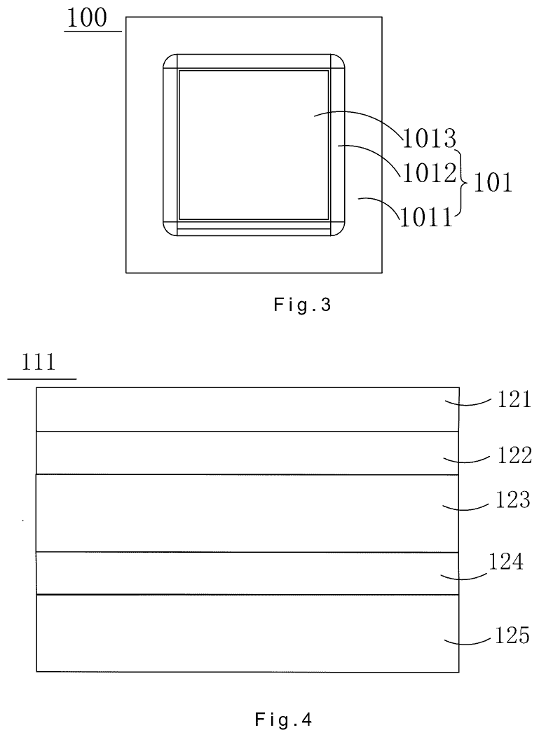

FIGS. 1 to 5 illustrate a speaker structure according to a first implementation of the present disclosure. The speaker structure 100 includes: a base 103 having a first surface and a second surface which are oppositely set, the base 103 having a first end 1031 and a second end 1032 which are oppositely set in first direction X; a diaphragm 102 secured to the first surface of the base 103, the diaphragm 101 and the base 103 enclosing a cavity 104; a drive part 110 disposed on the second surface, the drive part 110 driving the diaphragm 101 to vibrate, the drive part 110 including a first drive portion 111 and a second drive portion 112, the first driving portion 111 extending from the first end 1031 to the second end 1032, at least a segment of the first driving portion 111 being disposed above the cavity 104, the second driving portion 112 extending from the second end 1032 to the first end 1031, at least a segment of the second driving portion 112 being disposed above the cavity 104, the segments of the first drive portion 111 and the second drive portion 112 above the cavity 103 being set in a crosswise configuration; a first transmission part 105 disposed in the cavity 104, the first transmission part 105 corresponding to the first drive portion 111, one end of the first transmission part 105 being in contact with the first drive portion 111, another end thereof being in contact with the diaphragm 101; and a second transmission part 106 disposed in the cavity 104, the second transmission part 106 corresponding to the second drive portion 112, one end of the second transmission part 106 being in contact with the second drive portion 112, another end thereof being in contact with the diaphragm 101.

In this implementation, the base 103 of the speaker structure 100 is shaped as a square ring, the diaphragm 101 and the base 103 enclosing the cavity 104, the cavity 104 extending through the base 103 and serving as a vibration space for the speaker structure 100. Optionally, the base 103 may be a monocrystalline silicon base or of another type satisfying designed requirements.

In this implementation, since the base 103 is shaped as a square ring, the inner sides and the joints of the base 103 are chamfered, particularly filleted, which can reduce sharp features inside the speaker structure 100 and thus facilitates product assembly; in addition, this setting can also prevent the sharp features on the base 103 from contacting other internal components of the speaker structure 100 causing damages thereto.

The first drive portion 111 includes a first fixed section 1111 in contact with the first end 1031; and a plurality of first overhang sections 1112 spaced apart from one another along second direction Y, one end of each of the first overhang sections 1112 being connected to the first fixed section 1111, another end of the each of the first overhang sections 1112 being in contact with the first transmission part 105. By setting the plurality of first overhang sections 1112, each of the first overhang sections 1112 may serve as a deformable region of the first drive portion 111 driving the first transmission part 105 to cause deformation of the diaphragm 101. The plurality of first overhang sections 1112 impose an action force against a plurality of regions of the diaphragm 101, accumulating a large action force, which drives the diaphragm 101 to vibrate with a large amplitude to thereby produce a loud sound. In this way, within the limited vibration area, the sound pressure level may be raised by increasing the effective vibration amplitude.

The second drive portion 112 includes: a second fixed section 1121 in contact with the second end 1032, and a plurality of second overhang sections 1122 spaced apart from one another, one end of each of the second overhang sections 1122 being connected to the second fixed section 1121, another end thereof being in contact with the second transmission part 106, the plurality of first overhang sections 1112 and the plurality of second overhang sections 1122 being set in a crosswise configuration. Due to the crosswise setting between the first overhang sections 1112 and the second overhang sections 1122, the first drive portion 111 and the second drive portion 112 have a relatively long active length within the limited area, so that the first drive portion 111 and the second drive portion 112 achieve a large vibration amplitude, which induces a large vibration amplitude of the diaphragm 101, whereby the sound pression level is promoted.

The first transmission part 105 is in contact with end portions of the first overhang sections 1112 distal from the first end 1031. As such, the vibration arm of force driven by the first drive portion 111 is the length of the first drive portion 111, leading to a greater vibration amplitude, so that the diaphragm 101 is much deformed to disturb the air producing a higher sound pressure level.

The second transmission part 106 is in contact with end portions of the second overhang sections 1122 distal from the second end 1032. The vibration arm of force of the second drive portion 112 is also the length of the second drive portion 112, which can enhance the sound pressure level performance.

An interval within a first preset range L1 is existent between orthogonal projection of each of the first overhang sections 1112 on the diaphragm 101 and the second end 1032. In this way, due to the gap between the first overhang sections 1112 and the base 103, the first overhang sections 1112 may be prevented from contacting the base 103, so that no noise would be produced causing error to the emitted sound.

The first preset range L1 is from 10 μm to 2000 μm. Optionally, the first preset range L1 may be from 50 μm to 2000 μm. Furthermore, the first preset range L1 may be 50 μm, 100 μm, 200 μm, 300 μm, 400 μm, 500 μm, 600 μm, 700 μm, 800 μm, 900 μm, or 1000 μm.

An interval within a second preset range L2 is existent between orthogonal projection of each of the second overhang sections 1122 on the diaphragm 101 and the first end 1031. The second preset range L2 may improve accuracy of sound.

The second preset range L2 is from 10 μm to 2000 μm. Optionally, the second preset range L2 may be from 50 μm to 1000 μm. Furthermore, the second preset range L2 may be 50 μm, 80 μm, 130 μm, 250 μm, 410 μm, 520 μm, 610 μm, 710 μm, 820 μm, 910 μm, or 1000 μm.

Optionally, the interval between orthogonal projection of the first overhang section 1112 on the diaphragm 101 and the second end 1032 is identical to that between orthogonal projection of the second overhang section 1122 on the diaphragm 101 and the first end 1032.

Optionally, the first overhang sections 1112 and the base 103 may be fixed via a spring structure to prevent an excessive movement amplitude of the first overhang sections 1112. The second overhang sections 1122 and the base 103 may be fixed via a spring structure to prevent an excessive movement amplitude of the second overhang sections 1122.

The diaphragm 101 includes a first portion 1011, a second portion 1012, and a third portion 1013 which are sequentially connected, the first portion 1011 being disposed on the first surface, the third portion 1013 being in contact with the first transmission part 105 and the second transmission part 106, the second portion 1012 being disposed between the first portion 1011 and the third portion 1013; the second portion protrudes from the first portion 1011 in a direction towards the first drive portion 111 or protrudes from the first portion 1011 in a direction away from the first drive portion 111. In this way, since the second portion 1012 protrudes from the first portion 1011 in a direction towards the first drive portion 111 or protrudes from the first portion 1011 in a direction away from the first drive portion 111, the section of the second portion 1012 is an arched surround with a longer perimeter; under a same Poisson's ratio, the arched shape has a greater deformation than a flattened shape, so that the first overhang sections 1112 move more freely, which may achieve a greater vibration amplitude, driving the diaphragm 101 to disturb a larger volume of air to produce a higher sound pressure level.

The first portion 1011, the second portion 1012, and the third portion 1013 are organic membranes integrated into one piece. The organic membranes may be made of polydimethylsiloxane (PDMS) or polyimide or the like.

Optionally, a reinforced diaphragm 1014 is further provided at a side of the third portion 1013 distant from the cavity 104, overlap portions between the reinforced diaphragm 1014 and the third portion 1013 being securely connected to each other. The reinforced diaphragm 1014 has a yield strength greater than that of the third portion 1013, which thusly enhances the mechanical strength of the diaphragm 101 and extends the service life of the diaphragm 101.

Referring to FIG. 4, the first drive portion 111 includes a support layer 125, a bottom electrode layer 124, a piezoelectric layer 123, a top electrode layer 122, and a protective layer 121 which are stacked together. The support layer 125 may be made of SOI (Silicon On Insulator). The support layer 125 may be made of silicon dioxide or other insulating materials. The bottom electrode layer 124 may be made of platinum.

The piezoelectric layer 123 may be made of PZT (Lead Zirconate Titanate). Since the PZT membrane has a higher piezoelectric constant, the mechanic-electrical conversion efficiency can be enhanced, whereby the speaker drive ratio is improved. The top electrode layer 122 may be made of gold and platinum alloy. The protective layer 121 may be made of silicon nitride.

One insulative layer 109 is further provided between the first drive portion 111 and the base 103; the insulative layer 109 is made of silicon dioxide, which reduces the parasitic capacitance between the first drive portion 111 and the base 103 compared with a structure without an insulative layer.

The second drive portion may also include a support layer, a bottom electrode layer, a piezoelectric layer, a top electrode layer, and a protective layer which are stacked together. One insulative layer is also provided between the second drive portion and the base. The stacked structure of the second drive portion is identical to that of the first drive portion, which may specifically refer to the stacked structure of the first drive portion and is thusly not detailed here.

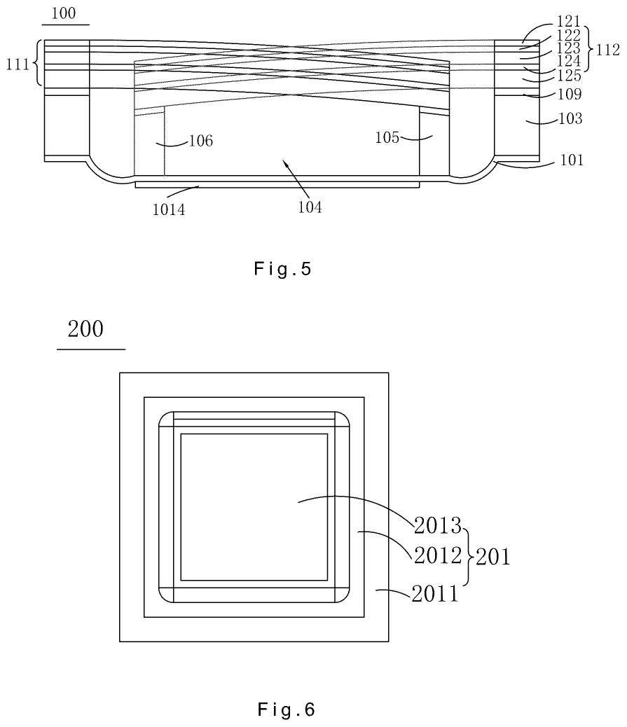

Referring to FIG. 5, when the first drive portion 111 is driven by an audio signal, the cantilever of the first overhang sections 1112 are located moves up and down, driving the first transmission part 105 to move, and the diaphragm 101 connected to the first transmission part 105 also moves along therewith, whereby a sound pressure is produced.

When the second drive portion 112 is driven by the audio signal, the cantilever where the second overhang sections 1122 are located moves up and down, driving the second transmission part 106 to move, and the diaphragm 101 connected to the second transmission part 106 also moves along therewith, whereby a sound pressure is produced. By extending the beam lengths of the cantilevers to the utmost extent, the terminal ends of the cantilevers may obtain a greater up-down movement amplitude, so that with a chip under a same size, a larger volume of air can be disturbed to produce a higher sound pressure level.

In the speaker structure 100 provided according to the present disclosure, a drive part 110 being in indirect contact with the diaphragm 101 is set, the drive part 110 including a first drive portion 111 and a second drive portion 112, segments of the first drive portion 111 and the second drive portion 112 above the cavity 104 being in a crosswise configuration so that within a limited area, the first drive portion 111 and the second drive portion 112 have a relatively long active length, i.e., by extending the beam length of the cantilever portion to the utmost extent, the terminal end of the cantilever of the first drive portion 111 and the terminal end of the cantilever of the second drive portion 112 may obtain a higher up-down movement amplitude; therefore, with a chip of a same size, a larger volume of air may be disturbed to produce a higher sound pressure level.

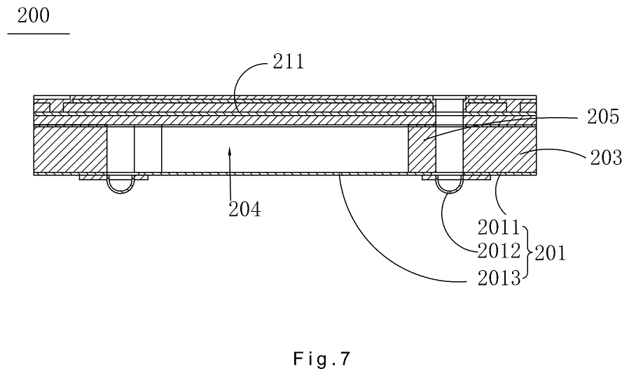

Referring to FIGS. 6-7, a second implementation of the present disclosure provides a speaker structure, which differs from the first implementation in that in the first implementation, the first portion, the second portion, and the third portion of the diaphragm are made of a same material, while in the second implementation, the material of the third portion is different from that of the first portion and the second portion. The remaining features are all identical, which will not be detailed here.

It is noted that, since the second implementation differs from the first implementation only in the diaphragm, the structural schematic diagram and the top view of the speaker structure according to the second implementation are not shown; the present disclosure only illustrates the bottom view and the sectional stereoscopic view of the speaker structure according to the second implementation. The unillustrated features of the speaker structure provided according to the second implementation may refer to the first implementation.

Referring to FIGS. 6-7, a speaker structure 200 includes: a base 203 having a first surface and a second surface which are oppositely set, the base 203 having a first end and a second end oppositely set in a first direction; a diaphragm 201 secured on the first surface of the base 203, the diaphragm 201 and the base 203 enclosing a cavity 204; a drive part disposed on the second surface, the drive part driving the diaphragm 201 to vibrate, the drive part including a first drive portion 211 and a second drive portion, the first drive portion 211 extending from the first end to the second end, at least a segment of the first drive portion 211 being disposed above the cavity 204, the second drive portion extending from the second end to the first end, at least a segment of the second drive portion being disposed above the cavity 204, the segments of the first drive portion 211 and the second drive portion disposed above the cavity 204 being set in a crosswise configuration; a first transmission part 205 disposed in the cavity 204, the first transmission part 205 corresponding to the first drive portion, one end of the first transmission part 205 being in contact with the first drive portion 211, another end thereof being in contact with the diaphragm 201; a second transmission part disposed in the cavity 204, the second transmission part corresponding to the second drive portion, one end of the second transmission part being in contact with the second drive portion, another end thereof being in contact with the diaphragm 201.

The diaphragm 201 includes a first portion 2011, a second portion 2012, and a third portion 2013 which are sequentially connected, the first portion 2011 being disposed on a third surface, the third portion 2013 being in contact with the first transmission part 205 and the second transmission part, the second portion 2012 being disposed between the first portion 2011 and the third portion 2013; the second portion 2012 protrudes from the first portion 2011 in a direction towards the first drive portion 211 or protrudes from the first portion 2011 in a direction away from the first drive portion 211.

At least one of the first portion 2011 and the second portion 2012 is an organic membrane, and the third portion 2013 is a rigid membrane; the third portion 2013 and the second portion 2012 are partially securely connected to each other. Since the third portion 2013 has a rigidity greater than the organic membrane, the diaphragm region corresponding to the third portion 2013 may maintain generally flattened during a whole process of up-down movement, without inducing other vibration profiles.

In the speaker structure 200 provided by the present disclosure, a drive part being in indirect contact with the diaphragm 201 is set, the drive part including a first drive portion 211 and a second drive portion, the segments of the first drive portion 211 and the second drive portion above the cavity 204 being set in a crosswise configuration, so that in a limited area, the first drive portion 211 and the second drive portion have a long active length, i.e., by extending the beam length of the cantilever portion to the utmost extent, the terminal end of the cantilever of the first drive portion 211 and the terminal end of the cantilever of the second drive portion may achieve a higher up-down movement amplitude; therefore, with a chip of the same size, a larger volume of air may be disturbed to produce a higher sound pressure level.

A person of normal skill in the art may understand, the implementations described supra are only specific examples of implementing the present disclosure; in actual applications, various modifications may be made in form and details without departing from the spirits and scope of the present disclosure.

I/We claim:

1. A speaker structure, comprising:
a base having a first surface and a second surface which are oppositely set, the base having a first end and a second end which are oppositely set along a first direction;
a diaphragm secured to the first surface of the base, the diaphragm and the base enclosing a cavity;
a drive part disposed on the second surface, the drive part driving the diaphragm to vibrate, the drive part comprising a first drive portion and a second drive portion, the first drive portion extending from the first end towards the second end, at least a segment of the first drive portion being disposed above the cavity, the second drive portion extending from the second end towards the first end, at least a segment of the second drive portion being disposed above the cavity, wherein the segments of the first drive portion and the second drive portion disposed above the cavity are set in a crosswise configuration;
a first transmission part disposed in the cavity, the first transmission part corresponding to the first drive portion, one end of the first transmission part being in contact with the first drive portion, another end thereof being in contact with the diaphragm;
and a second transmission part disposed in the cavity, the second transmission part corresponding to the second drive portion, one end of the second transmission part being in contact with the second drive portion, another end thereof being in contact with the diaphragm.

2. The speaker structure according to claim 1, wherein the first drive portion comprises a first fixed section in contact with the first end and a plurality of first overhang sections spaced apart from one another, one end of each of the first overhang sections being connected to the first fixed section, another end of the each of the first overhang sections being in contact with the first transmission part;
and the second drive portion comprises a second fixed section in contact with the second end and a plurality of second overhang sections spaced from one another, one end of each of the second overhang sections being connected to the fixed section, another end of the each of the second overhang sections being in contact with the second transmission part, the plurality of first overhang sections and the plurality of second overhang sections being set in a crosswise configuration.

3. The speaker structure according to claim 2, wherein the first transmission part is in contact with respective end portions of the first overhang sections distal from the first end;
and the second transmission part is in contact with respective end portions of the second overhang sections distal from the second end.

4. The speaker structure according to claim 2, wherein an interval within a first preset range is existent between orthogonal projection of the each of the first overhang sections on the diaphragm and the second end; and an interval within a second preset range is existent between orthogonal projection of the each of the second overhang sections on the diaphragm and the first end.

5. The speaker structure according to claim 4, wherein the first preset range is from 10 μm to 2000 μm; and the second preset range is from 10 μm to 2000 μm.

6. The speaker structure according to claim 1, wherein the diaphragm comprises a first portion, a second portion, and a third portion which are connected sequentially, the first portion being disposed on the first surface, the third portion being in contact with the first transmission part and the second transmission part, the second portion being disposed between the first portion and the third portion; and the second portion protrudes from the first portion in a direction towards the first drive portion or protrudes from the first portion in a direction away from the first drive portion.

7. The speaker structure according to claim 6, wherein the first portion, the second portion, and the third portion are organic membranes integrated into one piece.

8. The speaker structure according to claim 6, wherein at least one of the first portion and the second portion is made of organic membrane, and the third portion is made of rigid membrane.

9. The speaker structure according to claim 6, further comprising: a reinforced diaphragm disposed at a side of the third portion distant from the cavity.

10. The speaker structure according to claim 1, wherein the first drive portion comprises a support layer, a bottom electrode layer, a piezoelectric layer, a top electrode layer, and a protective layer stacked together.
